(19) United States
(12) Patent Application Publication
(10) Pub. No.: US 2016/0375285 A1
(43) Pub. Date: Dec. 29, 2016

(54) FLAME ARRESTOR ASSEMBLY

(71) Applicant: TESCOM CORPORATION, Elk River, MN (US)

(72) Inventors: Jacob T. R. Renollett, Andover, MN (US); Eric J. Burgett, McKinney, TX (US)

(73) Assignee: TESCOM CORPORATION, Elk River, MN (US)

(21) Appl. No.: 15/188,553

(22) Filed: Jun. 21, 2016

Related U.S. Application Data
(60) Provisional application No. 62/184,606, filed on Jun. 25, 2015.

(51) Int. Cl. A62C 4/02; F16L 55/10

(52) U.S. Cl. CPC A62C 4/02; F16L 55/1026

(57) ABSTRACT

A flame arrestor assembly configured to extinguish a flame propagating between a process control device and a combustible environment outside the process control device. The flame arrestor assembly includes a flame arrestor and a retaining element. The flame arrestor has a body adapted to be disposed within a fluid flow passageway of the process control device. The retaining element is adapted to be disposed within the fluid flow passageway of the process control device proximate to the flame arrestor, and is configured to securely retain the flame arrestor within the fluid flow passageway of the process control device.

### FIELD OF THE DISCLOSURE

The present disclosure is directed to a flame arrestor assembly and, more particularly, to a flame arrestor assembly for use in a process control device.

### BACKGROUND

Process control devices, e.g., valve controllers, may be operated in environments that are susceptible to explosions or fires. For example, valve controllers may control valves that control oil flow in a refinery or the flow of chemicals in a chemical plant or manufacturing facility. Valve controllers typically include modules having an enclosure that may accumulate fluids and/or gases from the potentially combustible environments. Sparks or overheating by electronics, wiring, or motors within the modules may ignite a fluid inside the module and initiate a flame, a fire, or an explosion. Because, in many cases, the modules include passages or channels that enable a fluid to flow between the outside of the enclosure or housing and the inside of the enclosure or housing to enable electronics of the module to measure properties of the fluid, there exists the risk that a flame, a fire, or an explosion initiated within the module will spread, via the passages or channels, to the potentially combustible environment outside the module.

To prevent such a flame, fire, or explosion from spreading from the module to the potentially combustible outside environment, a flame arrestor may be disposed within a channel or a passage of the module. A flame arrestor permits fluid to flow through the channel or passage and, at the same time, prevents (e.g., extinguishes) a flame, a fire, or an explosion from reaching the outside environment by absorbing heat associated with the flame, fire, or explosion. In other words, the flame arrestor enables a fluid to enter the module from the outside environment while preventing a fire or explosion from exiting a housing or enclosure of the module and igniting the outside environment.

Pursuant to ASME standards, a flame arrestor needs to be secured, in some manner, within the channel or passage of the module. In other words, a flame arrestor cannot rely on an interface fit (i.e., a press fit) to prevent displacement relative to the channel or passage of the module.

### SUMMARY

In accordance with one exemplary aspect of the present invention, a flame arrestor assembly, configured to extinguish a flame propagating between a process control device and a combustible environment outside the process control device, includes a flame arrestor and a retaining element. The flame arrestor has a body adapted to be disposed within a fluid flow passageway of the process control device. The body defines a first end and a second end, with the first end being adapted to be seated against a first end of the fluid flow passageway. The retaining element is adapted to be disposed within the fluid flow passageway of the process control device proximate to the flame arrestor. The retaining element is adapted to be disposed within the fluid flow passageway of the process control device proximate to the flame arrestor. The retaining element is configured to retain the flame arrestor within the fluid flow passageway of the process control device.

In accordance with another exemplary aspect of the present invention, a process control device includes an enclosure, at least one passageway formed within the enclosure, and a groove formed within the enclosure along the at least one passageway. The at least one passageway is defined by a first bore extending along an axis and having a first diameter, a second bore extending along the axis and having a second diameter different from the first diameter, and a chamfer connecting the first and second bores. The first bore is adapted to receive a flame arrestor configured to extinguish a flame propagating through the at least one passageway. The second bore is adapted to receive a threaded plug. The groove is formed proximate to the first bore and is adapted to receive a retaining element configured to retain the flame arrestor within the first bore.

In accordance with another exemplary aspect of the present invention, an assembly for use in a process control system includes a process control device and a flame arrestor assembly configured to be disposed in the process control device. The process control device includes an enclosure, at least one fluid flow passageway formed within the enclosure, and a groove formed within the enclosure along the at least one fluid flow passageway. The flame arrestor assembly includes a flame arrestor and a retaining element. The flame arrestor is configured to be disposed within the at least one fluid flow passageway to extinguish a flame propagating along the at least one fluid flow passageway. The retaining element is configured to be seated in the groove to retain the flame arrestor in the at least one fluid flow passageway.

### BRIEF DESCRIPTION OF THE DRAWINGS

The features of this invention which are believed to be novel are set forth with particularity in the appended claims. The invention may be best understood by reference to the following description taken in conjunction with the accompanying drawings, in which like reference numerals identify like elements in the several FIGS., in which:

FIG. 1 is a perspective view of one example of a flame arrestor assembly constructed in accordance with the principles of the present invention;

FIG. 2 is a perspective, transparent view of an example process control device constructed in accordance with the principles of the present invention and constructed to accommodate one or more of the flame arrestor assemblies illustrated in FIG. 1;

FIG. 3 is a cross-sectional view of a portion of the process control device of FIG. 2, showing the flame arrestor assembly of FIG. 1 arranged in a fluid flow passageway of the process control device of FIG. 2; and

FIG. 4 is similar to FIG. 3, but is a line drawing of the flame arrestor assembly of FIG. 1 arranged in a fluid flow passageway of the process control device of FIG. 2.

### DETAILED DESCRIPTION

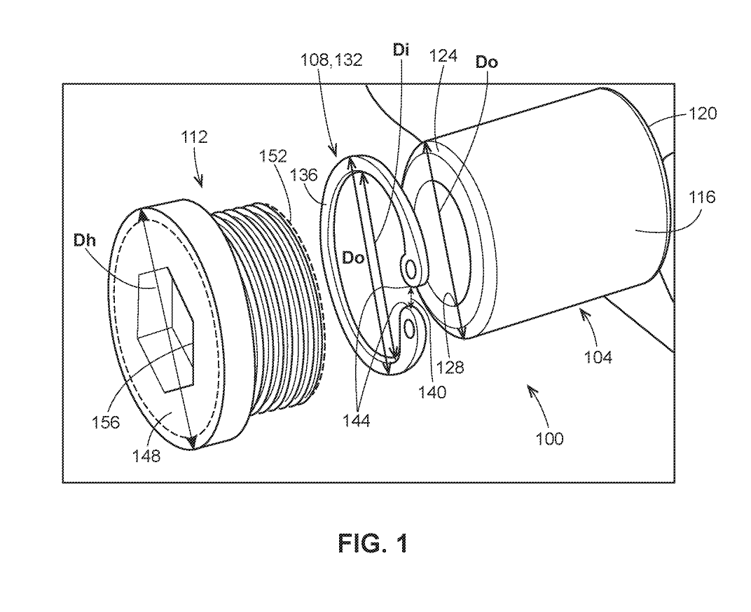

FIG. 1 illustrates a flame arrestor assembly 100 constructed in accordance with the principles of the present invention. The flame arrestor assembly 100 can be utilized or employed with any number of process control devices, e.g., valve controllers, as will be described in greater detail below. Once arranged (e.g., installed) in a process control device, the flame arrestor assembly 100 permits fluid to flow through a channel or passage of that process control device and, at the same time, prevents a flame, a fire, or an explosion from propagating between the process control device and an environment outside of the process control device. Accordingly, the flame arrestor assembly 100 prevents a flame, a fire, or an explosion exiting the process control device and igniting the outside environment.

As illustrated in FIG. 1, the flame arrestor assembly 100 in this example includes a flame arrestor 104, a retaining element 108, and a plug 112. In other examples, the flame arrestor assembly 100 can include more or less components. As an example, the plug 112 need not be part of the flame arrestor assembly 100. Moreover, it will be appreciated that the retaining element 108 can be integrally formed with, rather than structurally separate from, the flame arrestor 104. As an example, the retaining element 108 can be built into the side of the flame arrestor 104.

The flame arrestor 104, which can also be referred to as a filter, has a cylindrical body 116 made of any suitable material, such as, for example, a sintered material (e.g., stainless steel). The cylindrical body 116 has a first end 120 and a chamfered second end 124 opposite the first end 120. A passage 128 is defined between the first and second ends 120, 124 and through the body 116, thereby permitting fluid flow through the flame arrestor 104.

The retaining element 108 is generally sized and shaped to retain the flame arrestor 104 in position, once arranged or disposed in a process control device, as will be described in greater detail below. In the illustrated example, the retaining element 108 takes the form of a snap ring 132. The snap ring 132 has a substantially annular body 136 and a small gap 140 formed between opposing ends 144 of the annular body 136. As illustrated, the ends 144 are slightly wider than the rest of the body 136. The snap ring 132 has an outer diameter Dₒ that is greater than an outer diameter Dₒ of the body 116 and an inner diameter Dᵢ that is less than the outer diameter Dₒ of the body 116.

The plug 112 illustrated in FIG. 1 is an NPT plug having a cylindrical head portion 148, a threaded body portion 152, and a passage 156 defined through the head and body portions 148, 152 (though difficult to see in FIG. 1). The head portion 148 has a diameter Dₕ that is larger than the outer diameter Dₒ of the body 116 of the flame arrestor 104. The threaded body portion 152, meanwhile, has a diameter D_{b} that is smaller than the diameter Dₕ of the head portion 148 but slightly larger than the outer diameter Dₒ of the body 116 of the flame arrestor 104. As will be described in greater detail below, the threaded body portion 152 is generally configured to thread the plug 112 to the process control device utilizing the flame arrestor assembly 100.

In other examples, the flame arrestor assembly 100 can vary from what is illustrated in FIG. 1. More specifically, the flame arrestor 104, the retaining element 108, and/or the plug 112 can vary in shape, size, and/or construction. As an example, the body 116 of the flame arrestor 104 can have a larger or smaller diameter, based, for example, on the process control device that employs the flame arrestor 104. Likewise, the snap ring 132 can have a larger or smaller diameter, based, for example, on the process control device that employs the flame arrestor assembly 100 and/or the outer diameter Dₒ of the flame arrestor 104. As another example, the retaining element 108 can have a differently shaped body (e.g., a rectangular body) than the body 116. Moreover, in some examples, the retaining element 108 can take on a different form than the snap ring 132 (e.g. the retaining element 108 can be a threaded plug with a through hole or a spacer of sorts that is disposed between the flame arrestor 104 and the plug 112). Further, the plug 112 can, in other examples, take the form of a press-fit plug with a retaining method, a plug that is staked in place, or some other type of plug.

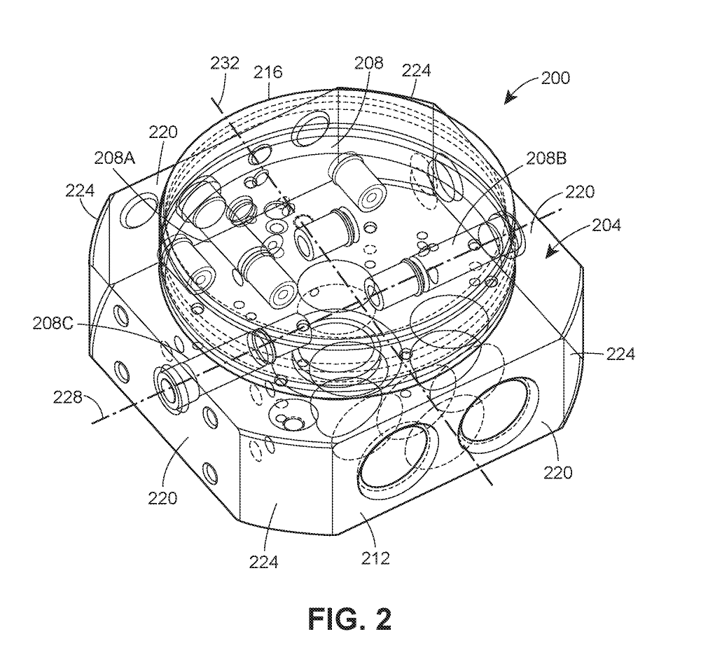

FIGS. 2-4 illustrate one example of a process control device 200 constructed, in accordance with the principles of the present invention, to accommodate a plurality of the flame arrestor assemblies 100 described above. The process control device 200 illustrated in FIGS. 2-4 takes the form of a valve controller (e.g., the TESCOM™ ER3000 or ER5000 controller) that includes a housing or enclosure 204 and a plurality of fluid flow passageways 208 formed or defined in the housing 204. For clarity purposes, only some of the fluid flow passageways 208, e.g., fluid flow passageways 208A, 208B, 208C, are referenced in FIG. 2. The valve controller is, as is generally known in the art, configured to monitor and control the position of a valve. Thus, it will be appreciated that the process control device 200 may also include sensors, electrical circuitry, amplifiers, converters, and/or other electrical components arranged in and/or on the housing 204, such that the process control device 200 can operate as intended.

As illustrated in FIG. 2, the housing 204 includes a base 212 and a cap 216 that is secured to and extends outward (in this case upward) from the base 212. The base 212 has a substantially rectangular shape defined by four rectangular (i.e., flat) walls 220 and four curved walls 224 extending between adjacent rectangular walls 220.

With reference still to FIG. 2, the fluid flow passageways 208 are formed or defined in the base 212 of the housing 204. Each fluid flow passageway 208 extends between one of the walls 220 of the base 212 and an interior portion of the base 212. Each of the fluid flow passageways 208 thus enables fluid communication between the process control device 200 (e.g., the electrical components of the process control device 200) and the environment outside of the process control device 200. While each fluid flow passageway 208 extends along or is parallel to an axis 228 or an axis 232, which is perpendicular to the axis 228, one or more fluid flow passageways 208 can, in other examples, extend along a different axis (e.g., an axis oriented at an angle to the axis 228 or the axis 232).

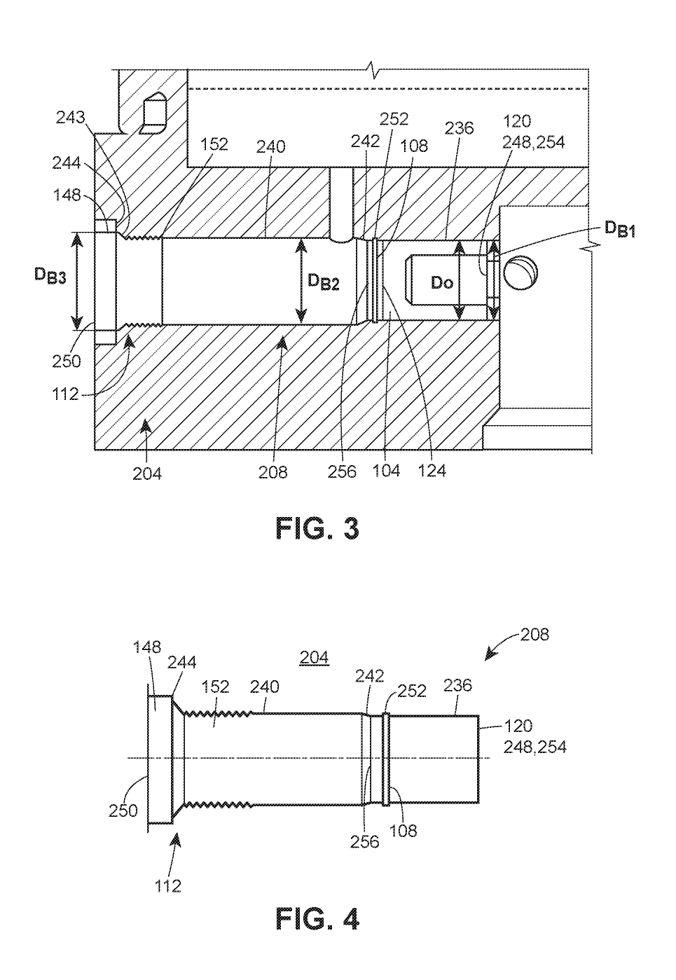

Each of the fluid flow passageways 208 (including the passageways 208A, 208B, 208C) is configured to accommodate one of the flame arrestor assemblies 100 discussed above. To this end, each fluid flow passageway 208, regardless of depth, includes or is defined by a first bore 236, a second bore 240, a first chamfer 242, a second chamfer 243, and a third bore 244, as illustrated in FIGS. 3 and 4. Of course, it will be understood that the depths of the first bore 236, the second bore 240, and/or the third bore 244 can vary depending upon the desired depth of the fluid flow passageway 208. The first bore 236, which extends between a first end 248 of the fluid flow passageway 208 and the chamfer 242, has a first diameter D_{B1} substantially equal to the outer diameter Dₒ of the body 116 of the flame arrestor 104, such that the first bore 236 is configured to receive one of the flame arrestors 104. As an example, the first diameter D_{B1} may be approximately 5/16″. The second bore 240, which extends between the chamfer 242 and the third bore 244, has a second diameter D_{B2} that is larger than the first diameter D_{B1} of the first bore 236. The second diameter D_{B2} is substantially equal to the diameter D_{b} of the body portion 152 of the plug 112 and at least a portion of the second bore 240 is threaded, such that the second bore 240 is configured to receive and threadingly retain the threaded body portion 152 of the plug 112 therein. As an example, the threaded portion of the second bore 240 may have a thread size of ⅛″ NPT, with the second diameter D_{B2} being in a range between approximately 0.323″ and 0.337″. The chamfer 242 connects the first bore 236 to the second bore 240 and generally serves to facilitate installation of the flame arrestor 104 and the retaining element 108 within the fluid flow passageway 208. In this example, the chamfer 242 has an angle of approximately 15 degrees, though in other examples, the angle can be approximately 10 degrees, approximately 20 degrees, approximately 30 degrees, or some other angle within a range of approximately 10 degrees to 30 degrees. The third bore 244 extends between the second bore 240 and a second end 250 of the fluid flow passageway 208. The third bore 244 has a third diameter D_{B3} that is larger than the first and second diameters D_{B1}, D_{B2} of the first and second bores 236, 240, respectively, and equal to or larger than the diameter Dₕ of the head portion 148 of the plug 112, such that the third bore 244 can receive the head portion 148 of the plug 112.

The process control device 200 also includes a circumferential groove 252 formed along each of the fluid flow passageways 208. As illustrated in FIGS. 3 and 4, each groove 252 is formed along the first bore 236, between first and second ends 254, 256 of the first bore 236, and proximate to the chamfer 242 (and thus proximate to the second bore 240). More specifically, each groove 252 is formed proximate to the second end 256 of the first bore 236, immediately adjacent the chamfer 242. Each groove 252 is, at least in this example, oriented or extends substantially perpendicular (e.g., perpendicular) to the axes 228, 232. Each groove 252 is arranged to receive and retain one of the retaining elements 108 therein, thereby positioning the retaining element 108 to retain the flame arrestor 104 within the respective fluid flow passageway 208 (and, more particularly, within the first bore 236 of the respective fluid flow passageway 208).

It will be appreciated that the process control device 200 can vary and yet still accommodate one or more of the flame arrestor assemblies 100, as desired. While the process control device 200 described herein takes the form of a valve controller, the process control device can, in other examples, take the form of an electronic heat controller or any other process control device suitable for a given application. Moreover, the process control device 200 can, in other examples, vary in shape, size, and/or construction. The housing 204 can vary in shape, size, and/or construction. The process control device 200 can, in some examples, include a different number of fluid flow passageways 208 (e.g., only one fluid flow passageway) and/or one or more of the fluid flow passageways 208 can be defined differently. As examples, one or more of the fluid flow passageways 208 need not include the third bore 244, the first and second bores 236, 240 can have different diameters than the bores 236, 240 illustrated in FIGS. 3 and 4 (e.g., the first and second bores 236, 240 can have the same diameter), and/or the second bore 240 need not be threaded (but could retain the plug 112 in a different way). Furthermore, while the groove 252 is formed along the first bore 236 at a position proximate to the chamfer 242 and is configured to receive and retain the snap ring 132, the groove 252 can, in other examples, be formed at a different position and/or sized to receive and retain a different retaining element 108.

The process for arranging or disposing (e.g., installing) one of the flame arrestor assemblies 100 in one of the fluid flow passageways 208 of the process control device 200 will now be described in connection with FIGS. 3 and 4. First, the flame arrestor 104 is inserted (e.g., by a tool) into the fluid flow passageway 208 via the third bore 244, inserted into and pushed through the second bore 240, and then inserted into and pushed through the first bore 236 until the first end 120 of the flame arrestor 104 is seated against the first end 248 of the fluid flow passageway 208. So arranged, the flame arrestor 104 will occupy a substantial portion of the first bore 236. Secondly, the retaining element 108 is inserted (e.g., by a tool) into the fluid flow passageway 208 via the third bore 244, inserted into and pushed through the second bore 240, and then inserted into and pushed partially through the first bore 236 until the retaining element 108 reaches the circumferential groove 252. At this point, the retaining element 108, which has a diameter larger than the first bore 236, expands, filling the groove 252. In other words, the retaining element 108 snaps or otherwise couples into place within the groove 252. So arranged, the retaining element 108, by virtue of having an inner diameter Dᵢ that is less than the outer diameter Dₒ of the body 116, serves to prevent the flame arrestor 104 from moving out of the fluid flow passageway 208, thereby securely retaining the flame arrestor 104 within the fluid flow passageway 208. Finally, the plug 112, which need not be considered part of the flame arrestor assembly 100, is inserted into the fluid flow passageway 208 via the third bore 244. The threaded body portion 152 of the plug 112 is threaded to and within the second bore 240, while the head portion 148 of the plug 112 is arranged or disposed within the third bore 244.

When the flame arrestor assembly 100 is arranged or disposed in one of the fluid flow passageways 208 of the process control device 200, as is illustrated in FIGS. 3 and 4, the flame arrestor assembly 100 enables fluid flow between the process control device 200 and the environment outside of the process control device 200, and, simultaneously, prevents a flame, a fire, or an explosion from propagating between the process control device 200 and the environment outside of the process control device 200.

Based on the foregoing description, it should be appreciated that the present disclosure provides a flame arrestor assembly that includes a flame arrestor for use in a process control device and a retaining element that is configured, when arranged or disposed in a process control device, to mechanically retain the flame arrestor within the process control device. The flame arrestor assembly thus complies with ASME standards governing the proper installation of a flame arrestor within a process control device.

It should also be appreciated that the present disclosure provides a process control device constructed to accommodate one or more of the flame arrestor assemblies described herein. The process control device includes one or more passageways each adapted to receive a flame arrestor and a groove formed along each of the one or more passageways for receiving and retaining a retaining element configured to retain the flame arrestor within the respective passageway. The process control device is thus configured to facilitate a quick and easy mechanical way of retaining a flame arrestor therein.

1. A flame arrestor assembly configured to extinguish a flame propagating between a process control device and a combustible environment outside the process control device, the flame arrestor assembly comprising:
a flame arrestor having a body adapted to be disposed within a fluid flow passageway of the process control device, the body defining a first end and a second end, the first end adapted to be seated against a first end of the fluid flow passageway; and
a retaining element adapted to be disposed within the fluid flow passageway of the process control device proximate to the flame arrestor, the retaining element configured to retain the flame arrestor within the fluid flow passageway of the process control device.

2. The flame arrestor assembly of claim 1, wherein the body of the flame arrestor is cylindrical.

3. The flame arrestor assembly of claim 1, wherein the flame arrestor is made of a sintered material.

4. The flame arrestor assembly of claim 1, wherein the retaining element comprises a snap ring.

5. The flame arrestor assembly of claim 4, wherein the snap ring has an outer diameter larger than an outer diameter of the flame arrestor and an inner diameter smaller than the outer diameter of the flame arrestor.

6. The flame arrestor assembly of claim 1, further comprising a plug adapted to be at least partially disposed within the fluid flow passageway of the process control device proximate to a second end of the fluid flow passageway.

7. The flame arrestor of claim 6, wherein the plug has a diameter that is different than a diameter of the flame arrestor.

8. A process control device, comprising:
an enclosure;
at least one passageway formed within the enclosure, the at least one passageway defined by a first bore extending along an axis and having a first diameter, a second bore extending along the axis and having a second diameter different from the first diameter, and a chamfer connecting the first and second bores, the first bore adapted to receive a flame arrestor configured to extinguish a flame propagating through the at least one passageway, the second bore adapted to receive a threaded plug; and
a groove formed within the enclosure along the at least one passageway, the groove formed proximate to the first bore and adapted to receive a retaining element configured to retain the flame arrestor within the first bore.

9. The process control device of claim 8, wherein the second diameter is larger than the first diameter.

10. The process control device of claim 8, wherein the at least one passageway is further defined by a third bore extending along the axis and having a third diameter different from the first and second diameters.

11. The process control device of claim 8, wherein the chamfer has an angle of between approximately 10 degrees to 30 degrees.

12. (canceled)

13. The process control device of claim 8, wherein the groove is formed immediately adjacent an end of the first bore.

14. The process control device of claim 8, wherein the groove is formed immediately adjacent the chamfer.

15. The process control device of claim 8, wherein the groove is formed between the chamfer and the end of the first bore.

16. The process control device of claim 8, wherein the groove is oriented substantially perpendicular to the axis.

17. An assembly for use in a process control system, comprising:
a process control device comprising:
an enclosure;
at least one fluid flow passageway formed within the enclosure; and
a groove formed within the enclosure along the at least one fluid flow passageway; and
a flame arrestor assembly configured to be disposed in the process control device, the flame arrestor assembly comprising:
a flame arrestor sized to be disposed within the at least one fluid flow passageway to extinguish a flame propagating along the at least one fluid flow passageway; and
a retaining element sized to be seated in the groove to retain the flame arrestor in the at least one fluid flow passageway.

18. The assembly of claim 17, wherein the at least one fluid flow passageway is defined by a first bore extending along an axis and having a first diameter, and a second bore extending along the axis and having a second diameter different from the first diameter, wherein the flame arrestor is disposed within the first bore, and wherein the groove is formed along the first bore.

19. The assembly of claim 18, wherein the at least one fluid flow passageway is further defined by a chamfer connecting the first and second bores, and wherein the groove is formed proximate to the chamfer.

20. The assembly of claim 18, wherein the second diameter is larger than the first diameter.

21. The assembly of claim 19, wherein the at least one passageway is further defined by a third bore extending along the axis and having a third diameter different from the first and second diameters.

22. (canceled)

23. (canceled)

24. The assembly of claim 18, wherein the groove is formed immediately adjacent an end of the first bore.

25. The assembly of claim 19, wherein the groove is formed immediately adjacent the chamfer.

26. The assembly of claim 19, wherein the groove is formed between the chamfer and the end of the first bore.

27. The assembly of claim 17, wherein the flame arrestor has a cylindrical body configured to be disposed within the fluid flow passageway, the cylindrical body defining a first end and a second end, the first end configured to be seated against a first end of the fluid flow passageway.

28. The assembly of claim 17, wherein the retaining element comprises a snap ring, the snap ring having an outer diameter larger than an outer diameter of the flame arrestor and an inner diameter smaller than the outer diameter of the flame arrestor.

29. (canceled)

30. The assembly of claim 17, further comprising a plug configured to be at least partially disposed within the fluid flow passageway of the process control device.
